(19) United States
(12) Patent Application Publication
(10) Pub. No.: US 2011/0069657 A1
(43) Pub. Date: Mar. 24, 2011

(54) SYSTEM AND METHOD FOR THE SIMULTANEOUS TRANSMISSION AND RECEPTION OF FLO AND FLO-EV DATA OVER A MULTI-FREQUENCY NETWORK

(75) Inventors: Ralph A. Gholmieh, San Diego, CA (US); Krishna K. Mukkavilli, San Diego, CA (US)

(73) Assignee: QUALCOMM Incorporated, San Diego, CA (US)

(21) Appl. No.: 12/876,969

(22) Filed: Sep. 7, 2010

Related U.S. Application Data
(60) Provisional application No. 61/240,961, filed on Sep. 9, 2009.

(51) Int. Cl. H04W 4/00

(52) U.S. Cl. 370/328

(57) ABSTRACT

A system for receiving data comprising a receiver configured to receive a radio frequency communication signal comprising at least one superframe, the at least one superframe having at least a first data stream encoded therein; and overhead information carried in the superframe, the overhead information comprising a control channel, the control channel having control channel information for separating the at least one first data stream from any other data streams encoded in the at least one superframe, where the at least first data stream and any other data streams may be carried on different radio frequency channels.

### CROSS REFERENCE TO RELATED APPLICATION

This application claims priority to and the benefit of the filing date of U.S. Provisional Application No. 61/240,961, entitled “MFN Support For FLO Rev A And FLO Rev B Operation In A Flo Network” filed on Sep. 9, 2009, the entirety of which is incorporated herein by reference.

### BACKGROUND

The continued development and implementation of wireless communications systems has made it possible to transmit a large amount of data over a radio frequency (RF) air interface. There are a number of technologies that can be used to broadcast video and other programming from a central location to a receiver device. Forward Link Only (FLO) is an example of a transmission methodology that uses a radio frequency (RF) air interface to broadcast video and other programming from one or more central locations to one or more receiver devices. The basic structure of a transmission block in FLO is referred to as a “superframe.” In one implementation, a superframe contains 1200 MAC time units and has a duration of one (1) second. A superframe contains pilot, control and data frames. Typically, four data frames, each containing one or both of wide-area and local-area data are part of a superframe.

The FLO methodology has been improved to increase bandwidth and data carrying capability. The enhanced FLO system is referred to as FLO-EV. The enhanced FLO-EV system introduced additional physical layer transmit modes and allows additional services and capacity to be carried on the FLO network. In addition, it is also possible to increase the bandwidth of such networks by using multiple radio frequency (RF) channels over which to transport the FLO and the FLO-EV data.

As used herein the term FLO transmitter and FLO receiver refers to transmitters and receivers that are compliant with Revisions 0 and A of TIA-1099. The term FLO-EV and FLO-EV receiver refers to transmitters and receivers that are compliant with Revision B of TIA 1099. In particular, a FLO-EV multicast logical channel (MLC) is an MLC that is compliant with Revision B of TIA 1099, but not compliant with earlier releases. A FLO-EV MLC is either a physical layer type 2 (PHY Type 2) MLC that is encoded with a turbo code that spans the bits in the 4 frames of a superframe, or a physical layer type 1 (PHY Type 1) MLC that is encoded similarly to Rev A of TIA-1099 but that has a different trailer and OIS (overhead information symbol) location record structure to allow a larger peak rate on the MLC.

However, the physical layer coding structure of FLO-EV is different from that of FLO, thereby introducing challenges when attempting to use a single RF channel or multiple RF channels for both FLO and FLO-EV data.

Therefore, it would be desirable to allow both FLO and FLO-EV data to be carried on the same RF channel or on multiple RF channels.

### SUMMARY

Embodiments of the invention include a system for receiving data comprising a receiver configured to receive a radio frequency communication signal comprising at least one superframe, the at least one superframe having at least a first data stream encoded therein; and overhead information carried in the superframe, the overhead information comprising a control channel, the control channel having control channel information for separating the at least one first data stream from any other data streams encoded in the at least one superframe, where the at least first data stream and any other data streams may be carried on different radio frequency channels.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating the basic elements of a forward link only (FLO) network.

FIG. 2 is a block diagram illustrating a portion of a receiver of the portable communication device of FIG. 1.

FIG. 3 is a block diagram illustrating an example of a superframe suitable for carrying FLO and FLO-EV data.

FIG. 4 is a graphical illustration showing a frame portion containing example multicast logical channels.

FIG. 5 is a diagram illustrating the system parameters message (SystemParameters Message) carried in the wide area OIS (or local-area OIS) of FIG. 3.

FIGS. 6A through 6D are diagrams illustrating various additional fields of the SystemParameters Message of FIG. 5 as it relates to an MLC Records Table.

FIGS. 6E through 6H are diagrams illustrating various additional fields of the SystemParameters Message of FIG. 5 as it relates to an extended MLC Records Table.

FIG. 7 is a block diagram illustrating the relationship among an MLC, the OIS, and the control channel (CC).

FIGS. 8A through 8C are diagrams illustrating various additional fields of the SystemParameters Message of FIG. 5.

FIGS. 9A through 9C are diagrams illustrating various additional fields of the SystemParameters Message of FIG. 5.

FIGS. 10A through 10E are diagrams illustrating various fields of the ENDM of FIG. 7.

FIG. 11 is a flowchart describing an exemplary power up sequence of a portable communication device of FIG. 11

FIG. 12 is a flowchart describing flow acquisition in a portable communication device of FIG. 1.

### DETAILED DESCRIPTION

The system and method for the simultaneous transmission and reception of FLO and FLO-EV data over a multi-frequency network will be described in the context of a receiver in a portable communication device having the ability to receive and discriminate between multiple data streams on a single radio frequency (RF) channel or on multiple RF channels.

The system and method for the simultaneous transmission and reception of FLO and FLO-EV data over a multi-frequency network can be implemented in hardware, software, or a combination of hardware and software. When implemented in hardware, the system and method for the simultaneous transmission and reception of FLO and FLO-EV data over a multi-frequency network can be implemented using specialized hardware elements and logic. When portions of the system and method for the simultaneous transmission and reception of FLO and FLO-EV data over a multi-frequency network are implemented in software, the software can be used to control the various components in a receiver of a portable communication device.

The software can be stored in a memory and executed by a suitable instruction execution system (microprocessor). The hardware portion of the system and method for the simultaneous transmission and reception of FLO and FLO-EV data over a multi-frequency network can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the system and method for the simultaneous transmission and reception of FLO and FLO-EV data over a multi-frequency network comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

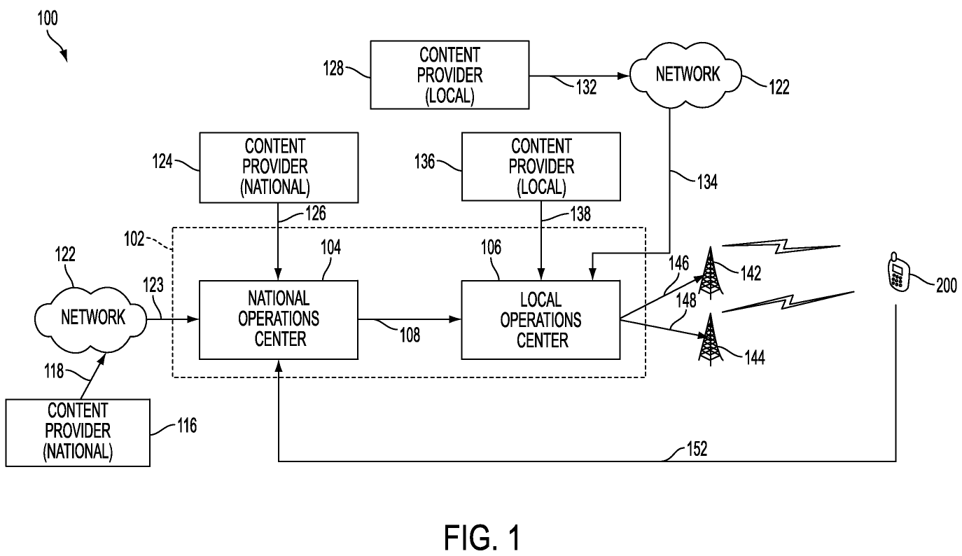

FIG. 1 is a block diagram illustrating the basic elements of a forward link only (FLO) network. The flow network 100 comprises a network operations center 102 one or more flow transmitters 142, 144, a reverse link 152 and one or more portable communication devices 200. In an embodiment, the network operations center 102 comprises a national operations center 104 and a local operations center 106. The national operations center 104 provides a national multiplex distribution stream over connection 108 to the local operations center 106. The connection 108 can be any high capacity communications channel.

The network operations center 102 receives content from a number of different sources over a number of different paths. Content may include, but is not limited to, data, audio, video, television programming, or other content. For example, the national operations center 104 can receive national content from a content provider 124 directly over a connection 126. The connection 126 can be a direct physical connection, a wireless connection or any other connection over which content can be provided to the national operations center 104. Alternatively, the national operations center 104 can receive national content from a content provider 116 over a network 122. The network 122 can be any of a wide area, a local area, or any other communications network over which content can be received over connection 118 from the content provider 116 and provided over connection 123 to the national operations center 104.

Similarly, the local operations center 106 can receive local content directly from a content provider 136 over connection 138. The connection 138 can be similar to the connection 126. Alternatively, the local operations center 106 can receive local content from a content provider 128 over the network 122 via connection 134. National content is content that can be provided to all portable communication devices 200, while local content is content that can be provided to a subset of all portable communication devices based on geographical location.

The network operations center provides the content to a wireless broadcast network embodied by transmitters 142 and 144. The transmitters 142 and 144 are intended to illustrate the entire infrastructure used to receive a terrestrial-based communication signal over connections 146 and 148, and to provide a wireless mobile broadcast transmission to the portable communication device 200. While the details of the FLO network are known to those having ordinary skill in the art, it should be mentioned that the FLO network is a diversity-type network in which multiple transmitters (e.g., transmitters 142 and 144) are used to send multiple signals having identical content from a number of transmitters to each portable device 200. The portable communication device 200 comprises any mobile or portable communication device, such as, for example, a cell phone, a personal digital assistant (PDA), a wireless television receiver, or any other portable communication device. The portable communication device 200 includes a receiver configured to receive the FLO transmission from the transmitters 142 and 144. Further, it is possible for the transmission to occur from the transmitters 142 and 144 to the portable communication device 200 using more than one RF channel, a so-called “multi frequency network (MFN).” As an example, FLO data can be carried over a first RF channel having a first radio frequency, FLO-EV data can be carried over a second RF channel having a second radio frequency, and both FLO and FLO-EV data can be carried on a third RF channel.

The portable communication device 200 is also coupled to the national operations center 104 via a reverse link 152. In an embodiment, the reverse link 152 can be a 3G, or a 4G wireless communication channel provided by a cellular communication carrier or provider. The reverse link 152 allows the portable communication device 200 to submit registration and authentication information to the national operations center 104 so that the portable communication device 200 receives the appropriate content. However, it should be mentioned that the transmission of content from the network operations center, via the flow transmitters 142 and 144, to the portable communication device 200 are one way only.

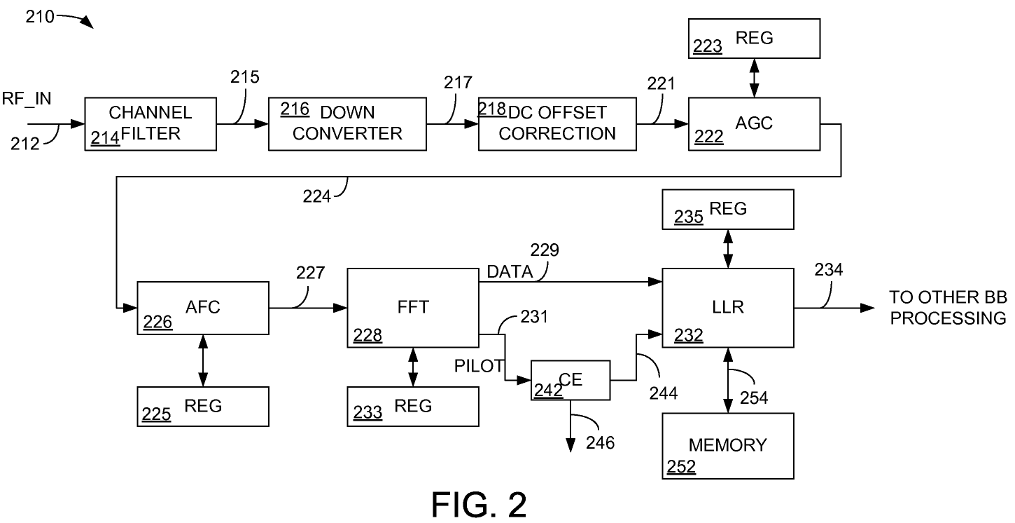

FIG. 2 is a block diagram illustrating a portion of a receiver of the portable communication device 200 of FIG. 1. The receiver portion 210 shown in FIG. 2 illustrates only the basic components of a receiver within the portable communication device 200. Details of a receiver are known to those having ordinary skill in the art. The receiver portion 210 receives a radio frequency (RF) signal over connection 212. The received RF signal is provided to a channel filter 212, which filters the received RF signal to develop a signal on connection 215 at the desired receive frequency. The RF signal on connection 215 is an analog signal that has undergone initial receiver processing, which may also include one or more of switching, low noise amplification or other front end receiver processing to prepare the RF signal for decoding.

The signal on connection 215 is provided to a downconverter 216. The downconverter 216 translates the signal on connection 215 from an RF signal to either an intermediate frequency (IF) or to baseband, or near-baseband if the receiver is implemented as a direct conversion receiver.

The signal on connection 217 is provided to a DC offset correction element 218, which corrects for any DC offset imparted to the signal in connection 217. The output of the DC offset correction element 218 is provided over connection 221 to an automatic gain control (AGC) element 222. The AGC element 222 adjusts the gain of the signal on connection 221 and provides a gain adjusted signal on connection 224. The AGC element 222 may comprises one or more analog and/or digital gain stages and can also convert the analog signal on connection 221 to a digital signal on connection 224.

The output on connection 224 is provided to an automatic frequency control (AFC) element 226. The AFC element 226 stabilizes the frequency of the signal on connection 224 and provides an output over connection 227 to the FFT element 228. The FFT element 228 provides a data output over connection 229 and provides a pilot symbol output over connection 231.

The data output of the FFT element 228 on connection 229 is provided to a log likelihood ratio (LLR) generator 232, which performs signal processing, and provides the data output to a turbo decoding element (not shown), and other processing elements over connection 234. The pilot symbol signal provided on connection 231 is provided to a channel estimate (CE) element 242. The CE element 242 provides the pilot symbol over connection 244 to the LLR generator 232 and also provides an estimate of the channel energy for each symbol over connection 246. A memory 252 is coupled to the LLR generator 232 over connection 254. The memory can be used to store the information on connections 229 and 244, and can be used to store the software for the system and method for the simultaneous transmission and reception of FLO and FLO-EV data over a multi frequency network.

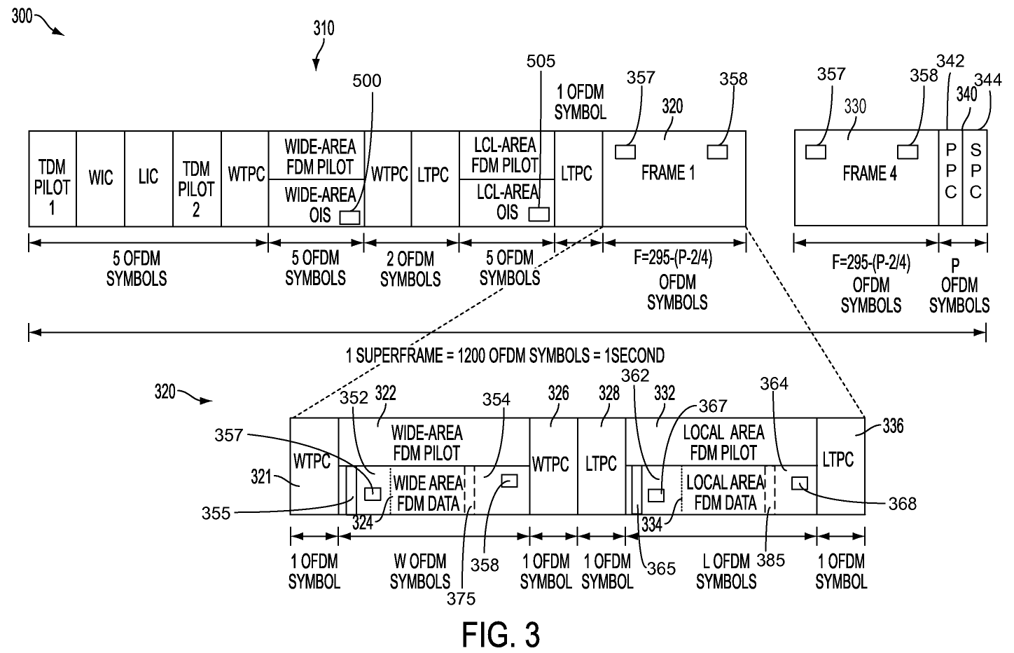

FIG. 3 is a block diagram illustrating an example of a superframe 300 suitable for carrying FLO and FLO-EV data over multiple RF channels. In an embodiment, the superframe 300 can be assembled by the network operations center 102 (FIG. 1) for transmission to the portable communication device 200 (FIG. 1). The superframe 300 comprises a preamble portion 310 that comprises pilot and OIS (overhead information symbol) information, frames 320 and 330, and portion 340, which includes positional pilot channel (PPC) 342 and signaling parameter channel (SPC) 344 as overhead information. The SPC 344 includes two bits that are used to indicate the physical device type (PHY Type 1 or PHY Type 2) for the particular radio frequency (RF), and includes two bits to indicate PPC status. By indicating the physical device type in the SPC 344 for the particular RF, the portable communication device 200 can determine whether it can receive and decode the contents of that particular RF.

The SPC 344 indicates a radio frequency (RF) type so that the portable communication device 200 uses the SPC 344 to set decoding registers prior to moving to a different RF channel The decoding registers can be registers 223, 225, 233 and 235 associated with the AGC element 222, AFC element 226, FFT element 228 and LLR generator 232, respectively. Further, additional registers will be associated with other decoder processing elements (not shown).

The PPC 342 includes PPC presence bits that the portable communication device 200 uses to determine whether PPC symbols are broadcast on an RF channel prior to decoding the RF channel. The SPC bits and PPC presence bits are part of the control channel (in the ENDM message to be described below) as well as in the SPC 344. The portable communication device 200 received and decodes the control channel to determine whether a new RF contains a PPC channel that should be considered. Two (2) bits in the SPC 344 also indicate in the PPC 342 is present or absent in that particular RF channel on which the SPC 344 is carried.

The PPC status allows the portable communication device 200 to determine whether the PPC status information may be available on the current RF channel, thus allowing the portable communication device 200 to determine whether it can use the PPC information for location determination or another purpose without needing a turbo decoder for decoding the OIS SystemParameters message. In addition, the portable communication device 200 can read the OIS information 500 and determine whether PPC location information are broadcast or not. Although four (4) frames are included in a superframe 300, only frames one (1) and four (4) are shown in FIG. 3 for simplicity of illustration.

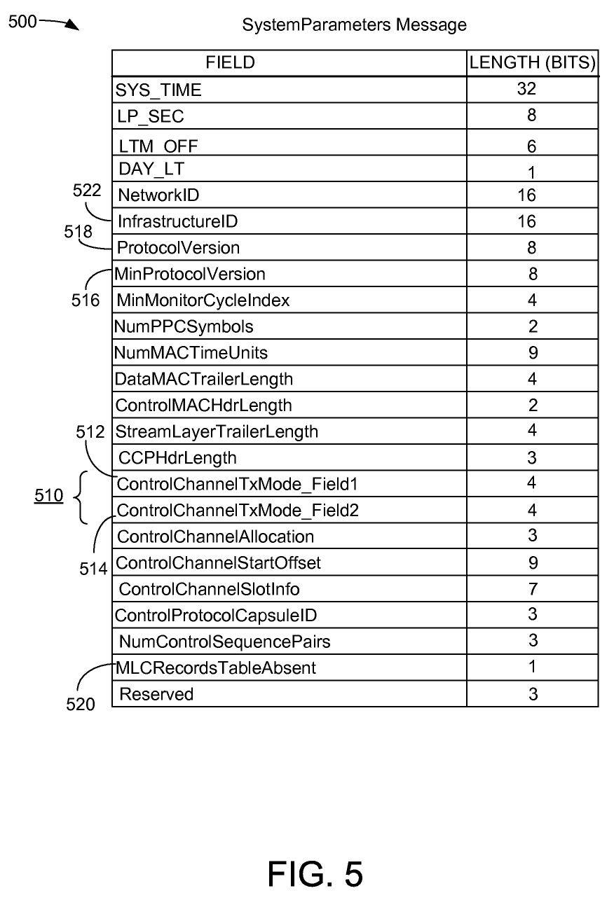

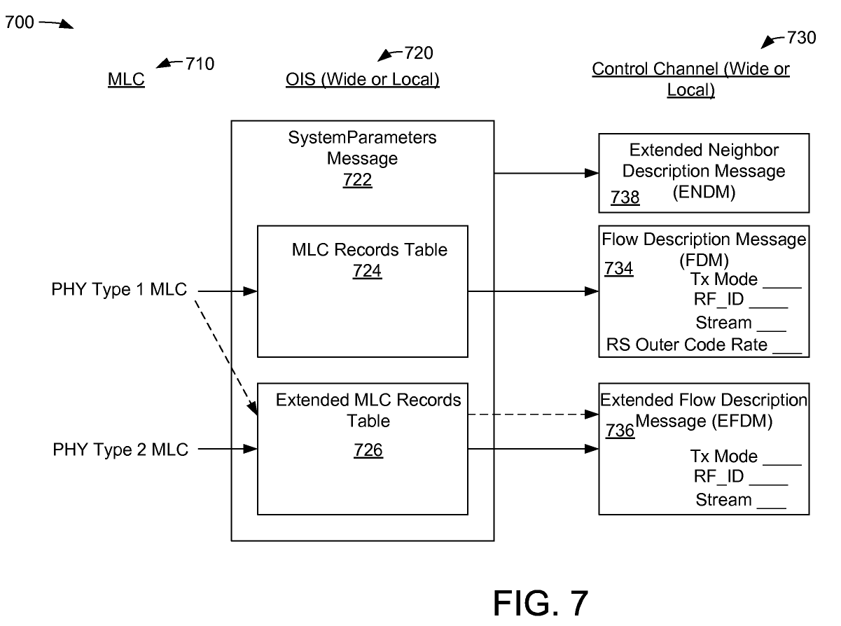

Furthermore, the PHY Type of an RF channel and PPC information can be listed in an extended neighbor description message (ENDM) (FIG. 7) to provide the device with prior knowledge of the encoding of other RF channels in the same local-area operational infrastructure (LOI), or of the RF channels in neighboring LOIs. An LOI is identified by the Infrastructure ID value (field 522 in FIG. 5) in the Local OIS. An LOI is the smallest geographic area over which the same set of multiplexed signals are broadcast over the exact same RF channels in the same manner. Thus, obtaining the ENDM and FDM and EFDM in the current LOI is sufficient to determine on which RF channel a flow is broadcast in the current LOI. The ENDM carries the mapping between RF_IDs used in the FDM and EFDM to identify RF channels, and physical RF channels characterized by the SPC parameters. The same content may be broadcast in two neighboring LOIs. If such is the case, then the LOI ID is a geographical identifier and can be used, for example, to determine whether certain channels are blacked out. Details of the fields in an ENDM are shown below.

The preamble 310 comprises 18 OFDM symbols in which TDM pilot channels occupy the first four symbols and a wide area transition pilot channel (WTPC) occupies the fifth symbol. The next five symbols are divided among wide area FDM pilot and wide area OIS information. The wide area OIS information portion includes a system parameters message 500, which will be described in greater detail below. The following two symbols comprise wide area transition pilot channel (WTPC) information and local area transition pilot channel (LTPC) information, while the following five symbols are divided between local area FDM pilot information and local area OIS information. The local area OIS information portion also includes a system parameters message 505, similar to the systems parameter message 500, for local OIS information. The following symbol comprises a local area transition pilot channel (LTPC).

Frames one through four are similar in structure so only frame one, 320, will be described in detail. Frame one, 320, comprises a wide area transition pilot channel (WTPC) 321 occupying a first symbol, “W” symbols comprising wide area FDM pilot information 322 and wide area FDM data 324, a single OFDM symbol comprising WTPC information 326, a single OFDM symbol comprising LTPC information 328, “L” OFDM symbols comprising local area FDM pilot information 322 and local area FDM data 334, followed by a single OFDM symbol 336 comprising the LTPC.

The superframe 300 can comprise both wide area and local area data, depending on system application. Further, in an embodiment, the superframe 300 can comprise data streams having both FLO and FLO-EV data. A FLO-EV multicast logical channel (MLC) is an MLC that is compliant with Revision B of TIA 1099, but not compliant with earlier releases. A FLO-EV MLC is either a physical layer type 2 (PHY Type 2) MLC that is encoded with a turbo code that spans the bits in the 4 frames of a superframe, or a physical layer type 1 (PHY Type 1) MLC that is encoded similarly to Rev A of TIA-1099 but that has a different trailer and OIS (overhead information symbol) location record structure to allow a larger peak rate on the MLC. A device capable of receiving PHY type 1 is able to decode transmit modes specific to PHY Type 1 transport. Similarly, a device capable of receiving PHY type 2 is able to decode transmit modes specific to PHY Type 2 transport. A PHY Type 1 transmit mode carries the data in what is referred to as a PHY Type 1 multicast logical channel (MLC) and a PHY Type 2 transmit mode carries the data in a PHY type 2 MLC. The term “transmit mode” refers to the transmit scheme used to send information from the transmitters 142, 144, to the portable communication device 200 (FIG. 1). A PHY Type 1 transmit mode generally uses a first set of RF carrier frequencies and a PHY Type 2 transmit mode generally uses a second set of RF carrier frequencies.

A PHY Type 1 transmit mode may be used to send the superframe 300 containing FLO data to a portable communication device 200; a PHY Type 2 transmit mode may used to send the superframe 300 containing FLO-EV data to a portable communication device 200; and PHY Type 1 and PHY Type 2 transmit modes may be used to send the superframe 300 containing FLO data and FLO-EV data to a portable communication device 200. Further, FLO data and FLO-EV data can be transported in the same superframe or in different superframes, only FLO data can be transported in a superframe, and only FLO-EV data can be transported in a superframe.

A portable communication device 200 can be implemented in a variety of ways to receive any or all of FLO and FLO-EV data in either or both of a PHY Type 1 transmit mode or a PHY Type 2 transmit mode, whether in the same superframe or in different superframes. In an embodiment, and for example purposes only, the portable communication device 200 can be considered a class 1 device that can receive and decode FLO data; a class 2 device that can receive and decode FLO-EV data; a class 3 device that can receive and decode FLO data and FLO-EV data in separate superframes, i.e., the device can either decode the FLO data being broadcast or the FLO-EV data being broadcast, but not both, in one superframe; and a class 4 device that can receive and decode FLO data and FLO-EV data in the same superframe.

When the superframe 300 comprises both FLO and FLO-EV data, the wide area FDM data portion 324 comprises a wide area FLO data portion 352 and a wide area FLO-EV data portion 354. Similarly, when the superframe 300 comprises both FLO and FLO-EV data, the local area FDM data portion 334 comprises a local area FLO data portion 362 and a local area FLO-EV data portion 364. Further, when there is no restriction on the location of FLO (PHY Type 1 device and MLC) and FLO-EV (PHY Type 2 device and MLC) and either or both of PHY Type 1 transmit modes and PHY Type 2 transmit modes. Corresponding MLCs may be carried anywhere within the wide area FDM data portion 324. Similarly, either or both of PHY Type 1 transmit modes and PHY Type 2 transmit modes, and corresponding MLCs, may be carried anywhere within the local area FDM data portion 334.

The wide area FDM data portion 324 comprises a control channel (CC) multicast logical channel (MLC) 355, and for example purposes only, comprises a FLO MLC 357 and a FLO-EV MLC 358. Similarly, the local area FDM data portion 334 comprises a control channel (CC) multicast logical channel (MLC) 365, and for example purposes only, comprises a FLO MLC 367 and a FLO-EV MLC 368. Control information associated with the CC MLC 355 is delivered to the wide service area over a plurality of radio frequency channels is identical regardless of transmit mode. Similarly, control information associated with the CC MLC 365 that is delivered to the local service area over a plurality of radio frequency channels is identical regardless of transmit mode.

In addition, the wide area FLO-EV data portion 354 may optionally include a wide area FLO-EV CC MLC 375; and the local area FLO-EV data portion 364 may optionally include a local area FLO-EV CC MLC 385. The inclusion of a wide area FLO-EV CC MLC 375 and a local area FLO-EV CC MLC 385 allows a control channel to be sent in a network that includes both PHY Type 1 devices and PHY Type 2 devices, and in a network that includes only PHY Type 2 devices. Furthermore, this embodiment is compatible with the first 3 classes of devices mentioned above, since a device would always be able to decode updates to the control channel to enable continued reception of data flows.

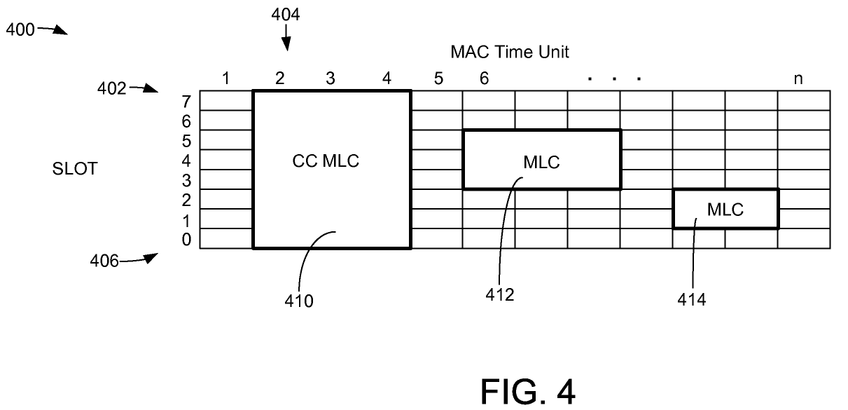

FIG. 4 is a graphical illustration 400 showing a frame portion 402 containing example multicast logical channels. The frame portion 402 can be part of either the wide area FDM data portion 324 (FIG. 3) or the local area FDM data portion 334 (FIG. 3). The frame portion 402 comprises a number (“W” or “L” of FIG. 3, depending on whether the subject frame contains wide area or a local area data) of symbols that can occur, for example, within the data portion 324 or 334 of the frame 320 of FIG. 3. The frame portion 402 contains a number of MAC time units 404, which are each further subdivided into eight (8) slots 406. In general, one MAC time unit is either ½ (if FFT=8K), 1 (if FFT=4K), 2 (if FFT=2K). or 4 (if FFT=1 K) OFDM symbols. A MAC time unit may be spread over multiple OFDM symbols. Each MLC is mapped to MAC time units.

For example purposes only, a control channel (CC) multicast logical channel (MLC) 410 is shown as spanning MAC time units 2, 3 and 4, and occurs within all of the slots 406.

For example purposes only, a first multicast logical channel (MLC) 412 is shown as spanning MAC time units 6, 7 and 8, and as occurring within slots 3-5. A second exemplary MLC 414 is shown as spanning MAC time units n-2 and n-1, and occurs within slots 1 and 2.

FIG. 5 is a diagram illustrating the system parameters message (SystemParameters Message) 500 carried in the wide area OIS (and 505 when carried in the local-area OIS) of FIG. 3. The SystemParameters Message comprises a number of information fields that define FLO and FLO-EV data, carried by PHY Type 1 and PHY Type 2 transmit modes, respectively, and that can also indicate the radio frequency (RF) information for different transmit modes. As an example, to support the availability of both FLO and FLO-EV data, the fields 510 are modified from that used in deployments with only PHY Type 1 transmit mode to accommodate a PHY Type 2 transmit mode as well. Previously, when carrying only PHY Type 1 MLCs, the field 512 referred to the transmit mode (modes 0 to 11, where modes 12 to 15 are unused), and the field 514 was the outer-code mode (0000=no outer code, 1= 14/16, 2= 12/16, 3= 8/16). This arrangement still applies if the subject MLC is PHY Type 1. If the subject MLC is a PHY Type 2 MLC, then the field 514 contains the 4 most significant bits of the 8 bit PHY Type 2 transmit mode, and the field 512 contains the 4 least significant bits of the 8 bit PHY Type 2 transmit mode. The following values of {field2} {field1} (field 514/field 512) are in use: {0000} {0000-1011} (i.e. values 0 to 11 indicating PHY Type 1 modes 0 to 11 with no outer code), {0001} {0000-1011} (i.e. values 16 to 27 indicating PHY Type 1 modes 0 to 11 with RS(14,16) outer code), {0010} {0000-1011} (i.e. values 32 to 43 indicating PHY Type 1 modes 0 to 11 with RS(12,16) outer code), {0011} {0000-1011} (i.e. values 48 to 59 indicating PHY Type 1 modes 0 to 11 with RS(8,16) outer code). This is the reason that PHY Type 2 transmit modes start at 64. It is possible to have filled the numerical gaps and used modes 12, 13, 14, 15, 28, 29, etc., but such would be less practical from a usability point of view. Therefore, possible combinations include FLO=>PHY Type 1 transmit modes, and new combinations for the two fields=>8 bit transmit mode numbers (PHY Type 2 modes are 64 to 72, and 80 to 91).

The field 512 comprises four (4) available bits for ControlChannelTXMode_Field1 information and the field 514 comprises four (4) available bits for ControlChannelTXMode_Field2 information. By including the fields 512 and 514, the SystemParameters Message 500 can signal to the receiver 210 within the portable communication device 200, a specific transmit mode that can support FLO and/or FLO-EV data. For example, the fields 512 and 514 can be used to carry information relating to a physical type 1 transmit mode that carries a first type MLC (PHY Type 1 MLC) or the fields 512 and 514 can be used to carry information relating to a physical type 2 transmit mode that carries a second type MLC (PHY type 2 MLC). A PHY Type 1 MLC and a PHY Type 2 MLC can be carried on the same RF channel or on different RF channels. In still another embodiment, a new field could be added to signal the presence of a second control channel with the understanding that the two control channels would carry the same data, but that one control channel would use a PHY Type 1 transmit mode for FLO devices, and that the second control channel would use a PHY type 2 transmit mode for a) greater coverage, and/or b) ability of devices decoding PHY Type 2 MLCs to simultaneously decode the control channel without requiring the receiver to be able decode PHY Type 1 and PHY Type 2 MLCs simultaneously.

The SystemParametersMessage 500 also includes a minimum protocol version (MinProtocolVersion) field 516 and a Protocol Version field 518. The field 516 is used to signal the minimum protocol version specified for the portable communication device 200 to receive a particular flow. For example, when the control channel MLC is sent using a transmit mode associated with FLO data (PHY Type 1) the MinProtocolVersion field 516 can be set to a logic “0” indicating that all devices can decode and interpret the OIS and the control channel. When the control channel MLC is sent using a transmit mode associated with FLO-EV data (PHY Type 2) the MinProtocolVersion field 516 can be set to a logic “2” indicating that PHY Type 1 devices cannot decode and interpret the OIS and the control channel.

The SystemParametersMessage 500 also includes a protocol version (ProtocolVersion) field 518. The field 518 is used to signal the current version of the Forward Link Only system protocol supported by the infrastructure. For example, in deployments where OIS and control channel are signaled using a PHY Type 1 transmit mode, and the data MLCs are sent using both PHY Type 1 and PHY Type 2 transmit modes, field 516 of the SystemParametersMessage 500 may be set to “0” and field 518 may be set to “2”.

The field 520, referred to as MLCRecordsTableAbsent, comprises a length of one bit, and is used to inform the receiver 210 whether the superframe 300 carries an MLC records table.

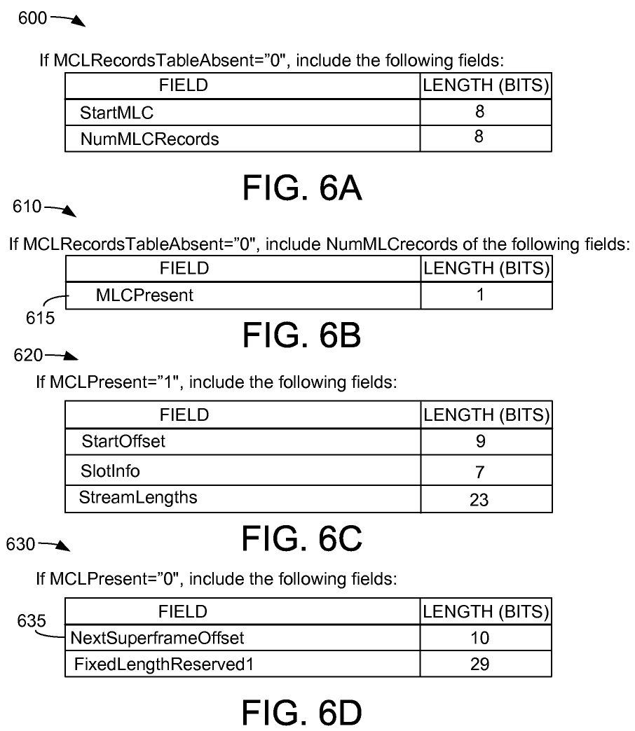

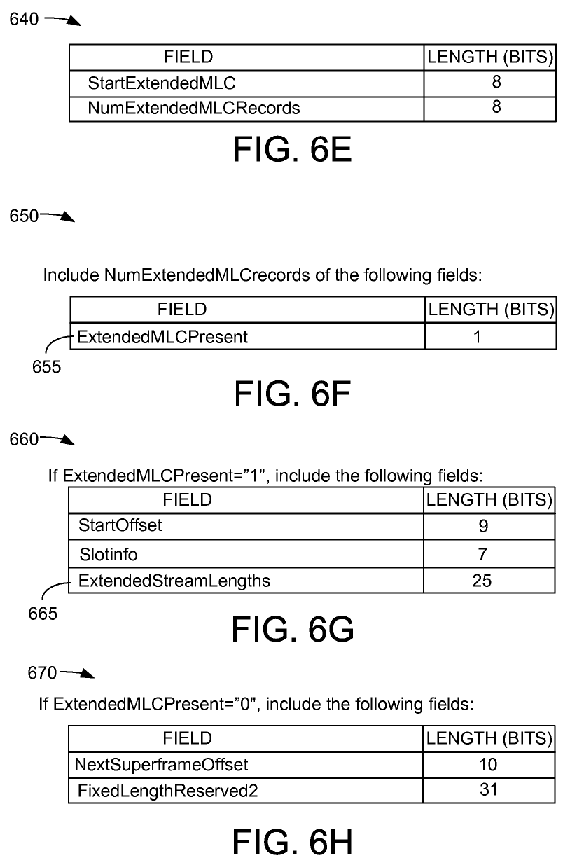

FIGS. 6A through 6D are diagrams illustrating various additional fields of the SystemParameters Message 500 of FIG. 5 as they relate to an MLC Records Table. In an embodiment, the additional fields can be added to an MLC in what is referred to as a “MAC trailer.” The diagram 600 illustrates a case where if the MLCRecordsTableAbsent field 520 (FIG. 5) is equal to logic “0”, then a StartMLC field having a length of eight (8) bits and a NumMLCRecords field having a length of eight (8) bits are included. When backward compatibility from a PHY Type 2 device to a PHY Type 1 device is desired, the StartMLC field, the NumMLCRecords field, and an MLC Records Table (FIG. 7) should always be present, and the MLCRecordsTableAbsent field 520 should be set to “0”. This bit may be set by the infrastructure in deployments with the minimum protocol version (field 516) set to “2”.

FIG. 6B shows a diagram 610 illustrating a case where if the MLCRecordsTableAbsent field 520 is equal to a logic “0”, then the NumMLCRecords of the field 615 (MLCPresent) is included. The field 615 has a length of one bit.

FIG. 6C shows a diagram 620 illustrating a case where if the MLCPresent field 615 (FIG. 6B) is equal to logic “1”, then the following fields are included: StartOffset, having a length of nine (9) bits; SlotInfo, having a length of seven (7) bits; and StreamLengths, having a length of 23 bits.

FIG. 6D shows a diagram 630 illustrating a case where if the MLCPresent field 615 (FIG. 6B) is equal to logic “0”, then the following fields are included; NextSuperframeOffset field 635, having a length of 10 bits; and FixedLengthReserved1, having a length of 29 bits.

FIGS. 6E through 6H are diagrams illustrating various additional fields of the SystemParameters Message 500 of FIG. 5 as they relate to an extended MLC Records Table.

FIG. 6E shows a diagram 640 illustrating an extended MLC Records table header including the following fields. StartExtendedMLC, having a length of eight (8) bits; and NumextendedMLCrecords, having a length of eight (8) bits.

FIG. 6F shows a diagram 650 illustrating a case where the NumExtendedMLCRecords of the following fields are included: ExtendedMLCPresent field 655, having a length of one (1) bit.

FIG. 6G shows a diagram 660 illustrating a case where if the ExtendedMLCPresent field 655 in FIG. 6F is equal to logic “1”, then the following fields are included: StartOffset, having a length of nine (9) bits; SlotInfo, having a length of seven (7) bits; and ExtendedStreamLengths, having a length of 25 bits. The ExtendedStreamLengths field 665 is made 2 bits longer than the StreamLengths field of FIG. 6C to allow a maximum number of packets on a larger stream that is 4 times greater than in the StreamLengths field. Further, the ExtendedStreamLengths field could be even longer (with no loss of generality) to increase the peak rate on medium and small streams as well.

FIG. 6H shows a diagram 670 illustrating a case where if the ExtendedMLCPresent field 655 in FIG. 6F is equal to logic “0”, then the following fields are included: NextSuperframeOffset, having a length of 10 bits; and FixedLengthReserved, having a length of 31 bits.

FIG. 7 is a block diagram 700 illustrating the relationship between an MLC, the OIS, and the control channel (CC). An MLC is generally shown using reference 710, the OIS is generally shown using reference 720 and the control channel is generally shown using reference 730.

In this example, the MLC 710 can be one of a physical type 1 MLC (PHY Type 1 MLC) or a physical type 2 MLC (PHY Type 2 MLC). In an embodiment, a portable communication device 200 that is capable of receiving a FLO transmission is only capable of decoding PHY Type 1 MLCs encoded using the protocols defined in Rev. 0 and A of TIA-1099. A portable communication device 200 that is capable of receiving a FLO-EV transmission is capable of decoding PHY Type 2 MLCs encoded using the protocols defined in Rev. B of TIA-1099. Further, it is possible that a single portable communication device 200 can be capable of receiving and decoding both a PHY Type 1 MLC and a PHY Type 2 MLC. Further still, it is possible that a single portable communication device 200 can be capable of receiving and decoding only a PHY Type 1 MLC, in which case all PHY Type 2 MLCs should be ignored. Moreover, it is possible that a single portable communication device 200 can be capable of receiving and decoding both a PHY Type 1 MLC and a PHY Type 2 MLC but not within the same superframe. Further, it is possible that a single portable communication device 200 can be capable of receiving and decoding a PHY Type 1 MLC, associated with a longer stream length (and thus higher peak rate), thus using the new trailer structure and the extended location table structure in OIS as defined in TIA 1099 Rev. B.

The OIS is shown as including SystemParameters Message 722. The SystemParameters Message 722 is similar to the SystemParameters Message 500 described above. However, the SystemParameters Message 722 is illustrated in FIG. 7 as including an MLC Records Table 724 and an Extended MLC Records Table 726.

The MLC Records Table 724 includes the MLC location information of all flows listed in the Flow Description Message (FDM) 734. Similarly, the Extended MLC Records Table 726 includes the MLC location information of all flows listed in the Extended Flow description Message (EFDM) 736. If only PHY Type 2 flows are broadcast, then all MLC location information will be carried in the EFDM 736. The FDM 734 and the EFDM 736 also include information, such as for example, Tx_Mode, RF_ID, Stream number, RS Outer Code Rate (if applicable for PHY Type 1 transmit mode), and other attributes of the respective data stream identified in the FDM 734 and/or EFDM 736.

The FDM 734 includes the flow description of all flows that are assigned to MLCs with transmit modes 0 through 4 and 6 through 11 and whose MLC locations are listed in the MLC Records Table 724. Similarly, the EFDM 736 includes the flow description of all flows that are assigned to MLCs with transmit modes 0 through 4 and 6 through 11 and whose MLC locations are listed in the Extended MLC Records Table 726; and includes the flow description of all flows that are assigned to MLCs with transmit modes 64 through 72 (regular) and 80 through 91 (layered) and whose MLC locations are listed in the Extended MLC Records Table 726. Any MLC ID listed in the EFDM 736 will be in the extended MLC Records Table 726.

It is also possible to describe a PHY Type 1 MLC in the EFDM 736 and in the extended MLC Records Table 726. This is indicated in FIG. 7 using dotted lines to indicate that it is optional. Describing a PHY Type 1 MLC in the EFDM 736 and in the extended MLC Records Table 726 takes advantage of the higher peak rate available with a PHY type 2 transmit mode. Furthermore, such MLCs would use the same MAC trailer syntax as a PHY Type 2 MLCs to be able to carry the longer length fields as defined in the extended MLC records table 726.

The flows described in the FDM 734 are decodable by PHY Type 1 devices and by PHY Type 2 devices. The flows described in the EFDM 736 are decodable by PHY Type 2 devices only.

In accordance with an embodiment of the system and method for the simultaneous transmission and reception of FLO and FLO-EV data over a multi frequency network, the Extended Flow Description Message 736 is readable only by a portable communication device 200 configured to receive FLO-EV data.

Control channel information for accessing the FLO data stream is placed in the FDM 734 and the control channel information for accessing the FLO-EV data stream is placed in the EFDM.

The control channel 730 also includes an Extended Neighbor Description Message (ENDM) 738. The ENDM 738 contains the exact frequency that corresponds to their RF_ID (radio frequency identifier) of the control channel, and all the MLCs contained within the FDM 734 and the EFDM 736. The ENDM is readable by both FLO and FLO-EV devices.

The locations of FLO and FLO-EV MLCs within the superframe can be placed in either the MLC Record Table 724, or in the extended MLC Records Table 726. A reason for segregating the MLCs in the SystemParameter message 722 with respect to the MLC Record Table 724 and the extended MLC Records Table 726 is that such separation aids transmission security and allows a clear design demarcation. The segregation scheme is done at the control channel level and thus a FLO device will never attempt to capture an MLC_IDs that carries FLO-EV data.

It is possible that a single portable communication device 200 can be capable of receiving both a PHY Type 1 MLC and a PHY Type 2 MLC on one or more different RF channels. A first data stream can be carried on a first RF carrier chosen from a first set of RF carriers, and a second data stream can be carried on a second RF carrier chosen from a second set of RF. Further, the first set of RF carriers and the second set of RF carriers may include carriers in common.

A number of embodiments are possible for the transport of FLO and FLO-EV data over one or more RF channels. For example, it is possible for an RF channel to either transmit FLO data or FLO-EV data. This arrangement has a relatively low implementation complexity, but such a network transitions from FLO data to FLO-EV data on an RF by RF basis.

Another embodiment allows a number of different RF channels to each transport both FLO data and FLO-EV data. In such an embodiment, all of the control channels are transported using PHY Type 1 transmit modes, or control channels could be sent simultaneously using both PHY Type 1 and PHY Type 2 and transmit modes.

Another embodiment allows a number of different RF channels to transport FLO-EV data only.

Either a single control channel or dual control channels (where one control channel is transported using a PHY type 1 transmit mode and the other control channel is transported using a PHY type 2 transmit mode) can be transported.

In a single control channel embodiment, the wide area control channel MLC and the local area control channel MLC are carried on the same RF channel.

The wide area or local area FDM (e.g., 734 of FIG. 7) carries the flow description of all wide area and local area flows carried by PHY Type 1 MLCs whose MLC locations are listed in the MLC records tables (e.g., 724 of FIG. 7) in the wide area and local area OIS.

The wide area or local area EFDM (e.g., 736 of FIG. 7) carries the flow description of all wide area and local area flows carried by PHY Type 2 MLCs whose MLC locations are listed in the Extended MLC records tables (e.g., 726 of FIG. 7) in the wide area and local area OIS.

In a dual control channel embodiment, the wide area control channel MLC and the local area control channel MLC for FLO data are carried on an RF channel compliant with a PHY Type 1 device and the wide area control channel MLC and the local area control channel MLC for FLO-EV data are carried on an RF channel compliant with a PHY Type 2 device.

If a portable communication device 200 receives OIS information with a minimum and maximum protocol version range that is out of range of the device capability, but that can be read by the device, the device treats that OIS as an OIS erasure and then scans other RF channels for another decodable OIS.

A device receiver can recognize that a current RF channel on which the control information is decoded is the only RF channel carrying a first data stream by checking that a single RF channel identifier (RF_ID) is in a corresponding location description of the first data stream.

The first set of RF carriers can correspond to a first set of RF channels and the second set of RF carriers can correspond to a second set of RF channels and the device receiver that is capable of decoding the first data stream can only decode data that is on one of the first set of RF channels.

The first set of RF carriers can correspond to a first set of RF channels and the second set of RF carriers can correspond a second set of RF channels and the device receiver that is capable of decoding a second data stream can only decode data that is on one of the second set of RF channels.

The first set of RF carriers can correspond to a first set of radio frequency (RF) channels and the second set of RF carriers can correspond a second set of RF channels the receiver that is capable of decoding the first data stream and the second data stream can decode data that is on one of the second set of RF channels.

A device receiving a PHY Type 1 MLC reads the FDM 734 and only recognizes RF_IDs carrying FLO (PHY type 1) MLCs. Thus, these devices will not attempt to decode FLO-EV data, or a PHY Type 2 RF channel. Thus, a device receiving a PHY type 1 MLC (FLO) will implicitly stay on a PHY Type 1 or a mixed PHY Type 1 and PHY type 2 RF channel.

A device receiving a PHY Type 2 MLC reads the EFDM 736 and only recognizes RF_IDs carrying FLO-EV (PHY type 2) MLCs. Thus, these devices will not attempt to decode FLO data, or a PHY Type 1 RF channel. Thus, a device receiving a PHY Type 2 MLC (FLO-EV) will implicitly stay on a PHY Type 2 RF channel.

If a device moves to a PHY Type 2 RF channel due to an interruption, such as an “out of coverage” period then reacquisition (or due to moving to another wide-area operational infrastructure (WOI)/local-area operational infrastructure (LOI)), then the device may scan a PHY Type 2 only RF channel. In this case, the device would continue to look for a FLO signal on other RF channels and treat the current RF channel as if there was no signal.

If a device finds only one RF channel in the FDM message, then the device assumes that it is on a single frequency network (SFN). In such an instance, the device would only assume that this is an SFN (or pseudo SFN for FLO devices ignoring FLO-EV RF channels), if the FDM message refers to only one RF_ID and simultaneously the MLC Records Table 724 is not empty. This condition will indicate that there is only a single RF channel carrying FLO MLCs, and that the subject RF channel is the current RF channel.

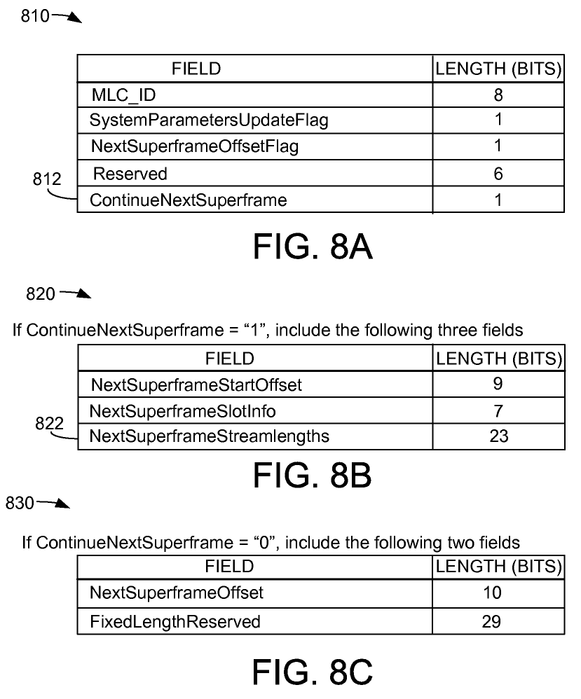

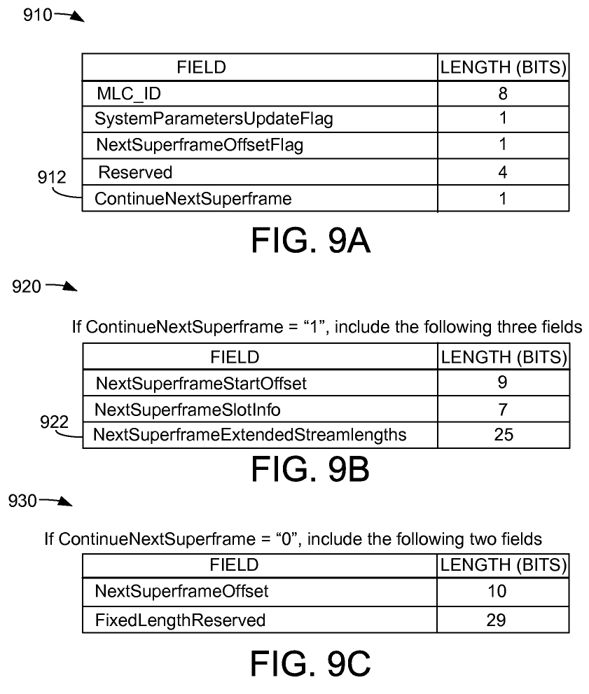

FIGS. 8A through 8C are diagrams illustrating various additional fields of the SystemParameters Message 500 of FIG. 5. The terminology “Future” to describe certain fields in FIGS. 8A through 9C is used interchangeably with the terminology “Next” used to describe certain fields in FIGS. 6A through 6H. Devices that are denoted as PHY Type 2 devices may require a longer decoding time than PHY Type 1 devices. Therefore, the media access control (MAC) layer trailer may not be decoded in sufficient time to allow for decoding the MLC in a subsequent superframe. The diagram 810 illustrates an additional trailer added to the SystemParameters Message 500 of FIG. 5. The diagram 810 shows an additional field 812, referred to as ContinueNextSuperframe, having a length of one (1) bit. The field 812 signals that the MAC trailer location information for the MLC is for the superframe whose start time is 2 seconds after the start time of the superframe in which the trailer appears.

FIG. 8B is a diagram 820 illustrating a case where if the ContinueNextSuperframe field 812 is equal to logic “1”, then a NextSuperframeStartOffset field having a length of nine (9) bits; a NextSuperframeSlotInfo field having a length of seven (7) bits; and a NextSuperframeStreamlengths field having a length of 23 bits are included, such that the MAC trailer location information for the MLC is for the superframe whose start time is 2 seconds after the start time of the superframe in which the trailer appears.

FIG. 8C is a diagram 830 illustrating a case where if the ContinueNextSuperframe field 812 is equal to logic “0”, then a NextSuperframeOffset field having a length of 10 bits; and a FixedLengthReserved field having a length of 29 bits are included, such that the MAC trailer location information for the MLC is for the superframe whose start time is 1 second after the start time of the superframe in which the trailer appears.

FIGS. 9A through C are diagrams illustrating various additional fields of the SystemParameters Message 500 of FIG. 5. FIGS. 9A through 9C are similar to FIGS. 8A through 8C, but include fewer reserved bits and additional Streamlength bits for FLO-EV data. Devices that are denoted as PHY Type 2 devices may require a longer decoding time than PHY Type 1 devices. Therefore, the media access control (MAC) layer trailer may not be decoded in sufficient time to allow for decoding the MLC in a subsequent superframe. The diagram 910 illustrates an additional trailer added to the SystemParameters Message 500 of FIG. 5. The diagram 910 shows an additional field 912, referred to as ContinueNextSuperframe, having a length of one (1) bit. The field 812 signals that the MAC trailer location information for the MLC is for the superframe whose start time is 2 seconds after the start time of the superframe in which the trailer appears.

FIG. 9B is a diagram 920 illustrating a case where if the ContinueNextSuperframe field 912 is equal to logic “1”, then a NextSuperframeStartOffset field having a length of nine (9) bits; a NextSuperframeSlotInfo field having a length of seven (7) bits; and a NextSuperframeExtendedStreamlengths field 922 having a length of 25 bits are included, such that the MAC trailer location information for the MLC is for the superframe whose start time is 2 seconds after the start time of the superframe in which the trailer appears. The NextSuperframeExtendedStreamlengths field 922 includes two additional bits than does the NextSuperframeStreamlengths field 822 of FIG. 8B.

FIG. 9C is a diagram 930 illustrating a case where if the ContinueNextSuperframe field 912 is equal to logic “0”, then a NextSuperframeOffset field having a length of 10 bits; and a FixedLengthReserved field having a length of 29 bits are included, such that the MAC trailer location information for the MLC is for the superframe whose start time is 1 second after the start time of the superframe in which the trailer appears.

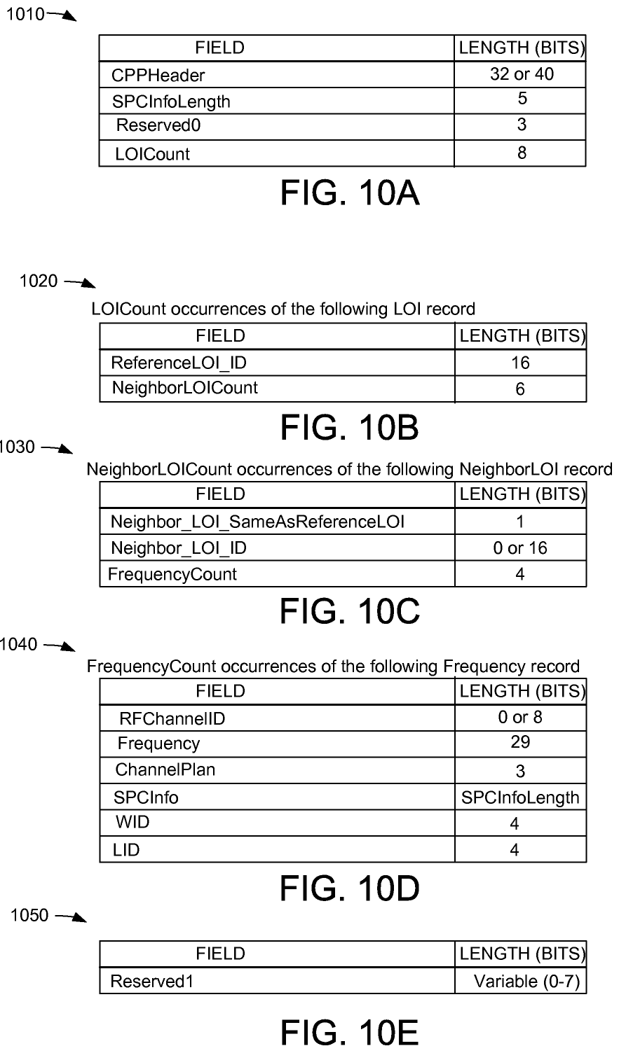

FIGS. 10A through 10E are diagrams illustrating various fields of the ENDM 738 of FIG. 7.

The diagram 1010 includes the fields CPPHeader, having a length of 32 or 40 bits; SPCInfoLength, having a length of five (5) bits; Reserved0, having a length of three (3) bits; and LOICount, having a length of eight (8) bits.

FIG. 10B is a diagram 1020 illustrating the LOICount occurrences of the following LOI record. The LOI record includes a Reference LOI_ID field having a length of 16 bits; and a NeighborLOICount field having a length of six (6) bits.

FIG. 10C is a diagram 1030 illustrating the LOICount occurrences of the following NeighborLOI record. The NeighborLOICount includes a Neighbor_LOI_SameAsReferenceLOI field having a length of one (1) bit; a Neighbor_LOI_ID field having a length of 0 or 16 bits; and a FrequencyCount field having a length of four (4) bits.

FIG. 10D is a diagram 1040 illustrating the FrequencyCount occurrences of the following Frequency record. The FrequencyCount includes an RFChannelID field having a length of 0 or eithg (8) bits; a Frequency field having a length of 29 bits; a ChannelPlan field having a length of three (3) bits; an SPCInfo field having a length of “SPCInfoLength”; a WID field having a length of four (4) bits; and an LID field having a length of four (4) bits.

FIG. 10E is a diagram 1050 illustrating a Reserved1 field having a variable length of between 0 and seven (7) bits.

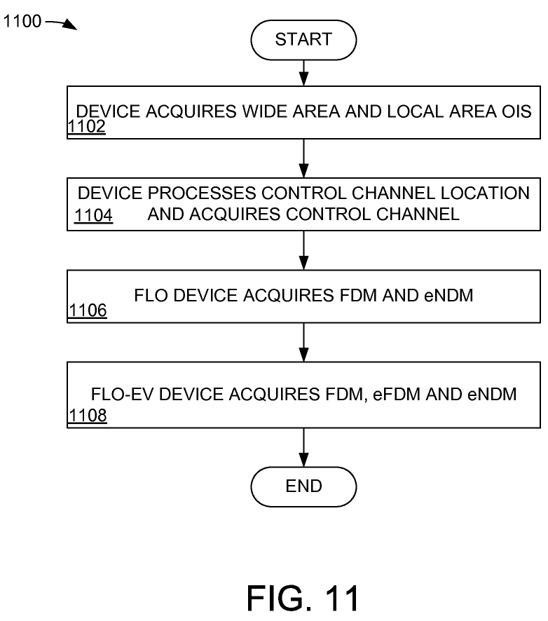

FIG. 11 is a flowchart describing an exemplary power up sequence of a portable communication device 200 of FIG. 1. In block 1102 the portable communication device 200 acquires the wide-area OIS and the local area OIS in the superframe 300 (FIG. 3).

In block 1104, the portable communication device 200 processes the control channel (CC) location and acquires the control channel. In block 1106, a portable communication device 200 configured to receive FLO data acquires the flow description message (FDM) and the extended neighbor description message (ENDM). The FDM is associated with the PHY Type 1 MLC that carries the FLO data, while the ENDM is not associated with an MLC.

In block 1108, a portable communication device 200 configured to receive FLO-EV data acquires the flow description message (FDM), the extended flow description message (EFDM) and the extended neighbor description message (ENDM). The FDM is associated with the PHY Type 1 MLCs that carry the FLO data and the EFDM is associated with the PHY Type 2 MLC that carries the FLO-EV data. In an embodiment, the EFDM 736 will carry description information for PHY Type 1 MLCs that are described in the extended MLC records table 726 in the OIS, and that use a MAC trailer structure that is similar to that of PHY Type 2 MLCs with the purpose of carrying up to 8192 bits worth of data (instead of the maximum limit of 2048 bits for FLO MLCs).

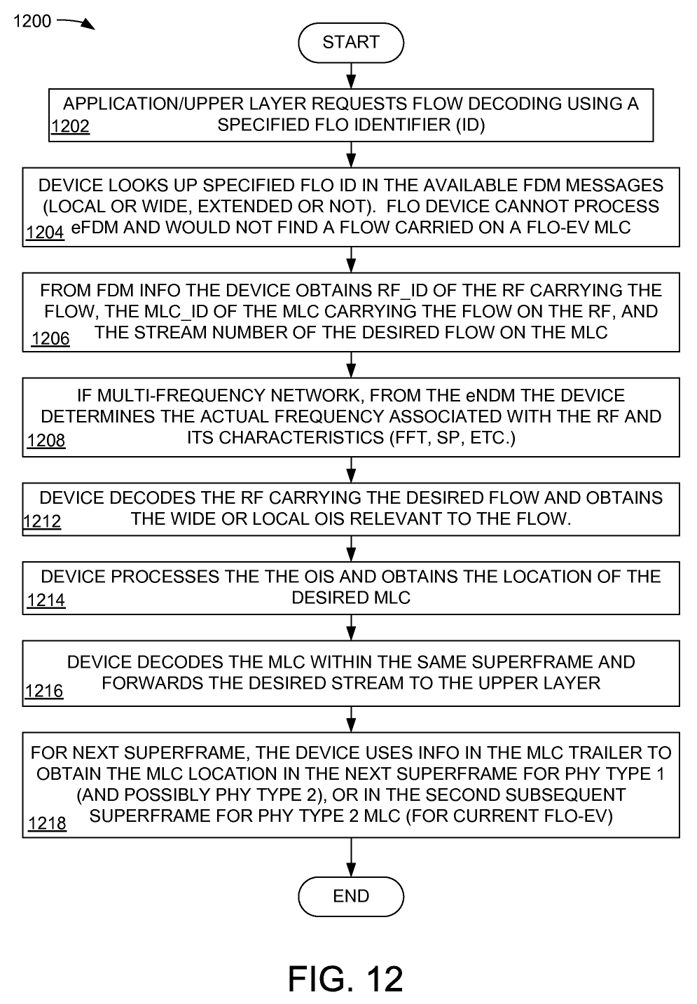

FIG. 12 is a flowchart describing flow acquisition in a portable communication device 200 of FIG. 1. In block 1202, an application/upper layer (not shown for simplicity) requests flow decoding using a specified flow identifier (FLO_ID). The FLO_ID is provided in the FDM and in the EFDM (FIG. 7). Regarding backward compatibility, the portable communication device 200 will receive the SystemParameters message 500 and 505 (FIG. 5) and will use the MinProtocolVersion field 516 and the ProtocolVersion field 518 to determine whether it can decode the subject RF channel. If the MinProtocolVersion field 516 is set to 0, then FLO devices, that accept version 0 and 1, can decode this RF, and the CC is sent using a PHY Type 1 transmit mode. This implies a dependency between the CC transmit mode and backward compatibility. The dependency exists because, in an embodiment, a single CC is implemented. In an alternative embodiment in which a CC is sent using both a PHY type 1 transmit mode and a PHY Type 2 transmit mode, the second CC information is added at the end of the message similarly to the extended MLC location table. If backward compatibility is not desired, then the MinProtocolVersion field 516 and ProtocolVersion field 518 can be set to 2, and then the CC mode can be a PHY Type 2 transmit mode if desired.

In block 1204, the portable communication device 200 looks up the specified FLO_ID in the available FDM 734 or EFDM 736 (local or wide). A portable communication device configured to process only FLO data cannot process the EFDM 736 and would not find a flow carried on a FLO-EV MLC.

In block 1206, from the FDM 734, the portable communication device 200 obtains the RF_ID of the radio frequency signal carrying the flow, the MLC ID of the MLC carrying the flow on the radio frequency signal, and the stream number of the desired flow on the MLC.

In block 1208, if a multiple frequency network is implemented, from the extended neighbor description message 738, the portable communication device 200 determines the actual frequency associated with the RF and its radio characteristics.

In block 1212, the portable communication device 200 decodes the radio frequency signal carrying the desired flow and obtains the wide or local OIS relevant to the particular flow.

In block 1214, the portable communication device 200 processes the OIS and obtains the locations of the desired MLC.

In block 1216, the portable communication device 200 decodes the MLC within the same superframe and forwards the desired stream to the application/upper layer.

In block 1218, for the next superframe, the portable communication device 200 uses information in the MLC trailer to obtain the MLC location in the next superframe for FLO, a PHY Type 1 or PHY Type 2 MLCs with the trailer flag NextSuperframeOffsetFlag set to 0, or in the second subsequent superframe for a PHY Type 2 MLC with the trailer flag NextSuperframeOffsetFlag set to 1.

While various embodiments of the invention have been described, it will be apparent to those of ordinary skill in the art that many more embodiments and implementations are possible that are within the scope of the invention.

What is claimed is:

1. A system for receiving data, comprising:
a receiver configured to receive a radio frequency communication signal comprising at least one superframe, the at least one superframe having at least a first data stream encoded therein; and
overhead information carried in the superframe, the overhead information comprising a control channel, the control channel having control channel information for separating the at least one first data stream from any other data streams encoded in the at least one superframe, where the at least first data stream and any other data streams may be carried on different radio frequency channels.

2. The system of claim 1, wherein the first data stream corresponds to a first set of transmit modes and a second data stream corresponds to a second set of transmit modes.

3. The system of claim 2, wherein the overhead information includes information about the data stream types carried on a radio frequency channel.

4. The system of claim 2, wherein the overhead information includes information about the presence of a pilot positioning channel.

5. The system of claim 2, wherein the first data stream is received over a first radio frequency (RF) carrier chosen from a first set of RF carriers, and the second data stream is received over a second RF carrier chosen from a second set of RF carriers.

6. The system of claim 5, wherein the first set of RF carriers and the second set of RF carriers have selected RF carriers in common where the first data stream and the second data stream are carried.

7. The system of claim 5, wherein a location description of the first data stream further comprises control information that is related to at least one capability of the receiver and a location description of the second data stream comprises control information that is related to at least a second capability of the receiver.

8. The system of claim 5, wherein the receiver can recognize that a current RF channel on which the control information is decoded is the only RF channel carrying the first data stream by checking that a single RF channel identifier (RF_ID) is in a corresponding location description of the first data stream.

9. The system of claim 5, wherein the first set of RF carriers correspond to a first plurality of radio frequency (RF) channels and the second set of RF carriers correspond a second plurality of RF channels and wherein the receiver capable of decoding the first data stream can only decode data that is on one of the first plurality of RF channels.

10. The system of claim 5, wherein the first set of RF carriers correspond to a first plurality of radio frequency (RF) channels and the second set of RF carriers correspond to a second plurality of RF channels and wherein the receiver capable of decoding the second data stream can only decode data that is on one of the second plurality of RF channels.

11. The system of claim 5, wherein the first set of RF carriers correspond to a first plurality of radio frequency (RF) channels and the second set of RF carriers correspond to a second plurality of RF channels and wherein the receiver capable of decoding the first data stream and the second data stream can decode data that is on one of the second plurality of RF channels.

12. The system of claim 1, further comprising:
a first service area to which the first and second data streams are delivered; and
a second service area to which the first and second data streams are delivered;
wherein control information that is delivered to the first service area over control channels on a plurality of radio frequency channels is identical regardless of transmit mode.

13. The system of claim 1, further comprising:
a first service area to which the first and second data streams are delivered; and
a second service area to which the first and second data streams are delivered;
wherein control information that is delivered to the second service area over control channels on a plurality of radio frequency channels is identical regardless of transmit mode.

14. The system of claim 1, further comprising:
a signaling parameter channel information (SPC) field in the control channel, the signaling parameter channel information field indicating a radio frequency (RF) type, wherein the receiver uses the signaling parameter channel information field to set decoding registers in the receiver prior to moving to a different RF channel.

15. The system of claim 1, further comprising:
a signaling parameter channel information (SPC) field in the control channel, the signaling parameter channel information field comprising positioning pilot channel (PPC) presence bits, wherein the receiver uses the PPC presence bits to determine whether PPC symbols are broadcast on an RF channel prior to decoding the RF channel.

16. A method for receiving data, comprising:
receiving a radio frequency communication signal comprising at least one superframe, the at least one superframe having at least a first data stream encoded therein; and
providing overhead information in the superframe, the overhead information comprising a control channel, the control channel having control channel information for separating the at least one first data stream from any other data streams encoded in the at least one superframe, where the at least first data stream and any other data streams may be carried on different radio frequency channels.

17. The method of claim 16, wherein the first data stream corresponds to a first set of transmit modes and a second data stream corresponds to a second set of transmit modes.

18. The method of claim 17, further comprising information about the data stream types carried on a radio frequency channel included in the overhead information.

19. The method of claim 17, further comprising information about the presence of a pilot positioning channel included in the overhead information.

20. The method of claim 17, further comprising receiving the first data stream over a first radio frequency (RF) carrier chosen from a first set of RF carriers, and receiving the second data stream over a second RF carrier chosen from a second set of RF carriers.

21. The method of claim 20, wherein the first set of RF carriers and the second set of RF carriers have selected RF carriers in common where the first data stream and the second data stream are carried.

22. The method of claim 20, wherein a location description of the first data stream further comprises control information that is related to at least one capability of the receiver and a location description of the second data stream comprises control information that is related to at least a second capability of the receiver.

23. The method of claim 20, wherein the receiver recognizes that a current RF channel on which the control information is decoded is the only RF channel carrying the first data stream by checking that a single RF channel identifier (RF_ID) is in a corresponding location description of the first data stream.

24. The method of claim 20, wherein the first set of RF carriers correspond to a first plurality of radio frequency (RF) channels and the second set of RF carriers correspond a second plurality of RF channels and wherein a receiver can only decode data that is on one of the first plurality of RF channels.

25. The method of claim 20, wherein the first set of RF carriers correspond to a first plurality of radio frequency (RF) channels and the second set of RF carriers correspond to a second plurality of RF channels and wherein a receiver can only decode data that is on one of the second plurality of RF channels.

26. The method of claim 20, wherein the first set of RF carriers correspond to a first plurality of radio frequency (RF) channels and the second set of RF carriers correspond to a second plurality of RF channels and wherein a receiver capable of decoding the first data stream and the second data stream can decode data that is on one of the second plurality of RF channels.

27. The method of claim 16, further comprising:
delivering the first and second data streams to a first service area; and
wherein control information that is delivered to the first service area over control channels on a plurality of radio frequency channels is identical regardless of transmit mode.

28. The method of claim 16, further comprising:
delivering the first and second data streams to a first service area; and
delivering the first and second data streams to a second service area;
wherein control information that is delivered to the second service area over control channels on a plurality of radio frequency channels is identical regardless of transmit mode.

29. The method of claim 16, further comprising:
providing a signaling parameter channel information (SPC) field in the control channel, the signaling parameter channel information field indicating a radio frequency (RF) type, wherein the receiver uses the signaling parameter channel information field to set decoding registers in a receiver prior to moving to a different RF channel.

30. The method of claim 16, further comprising:
providing a signaling parameter channel information (SPC) field in the control channel, the signaling parameter channel information field comprising positioning pilot channel (PPC) presence bits, wherein the receiver uses the PPC presence bits to determine whether PPC symbols are broadcast on an RF channel prior to decoding the RF channel.

31. A system for transmitting data, comprising:
a transmitter configured to transmit a radio frequency communication signal comprising at least one superframe, the at least one superframe having at least a first data stream encoded therein; and
overhead information carried in the superframe, the overhead information comprising a control channel, the control channel having control channel information for separating the at least one first data stream from any other data streams encoded in the at least one superframe, where the at least first data stream and any other data streams may be carried on different radio frequency channels.

32. The system of claim 31, wherein the first data stream corresponds to a first set of transmit modes and the second data stream corresponds to a second set of transmit modes.

33. The system of claim 32, wherein the overhead information includes information about the data stream types carried on a radio frequency channel.

34. The system of claim 32, wherein the overhead information includes information about the presence of a pilot positioning channel.

35. The system of claim 32, wherein the first data stream is broadcast over a first radio frequency (RF) carrier chosen from a first set of RF carriers, and the second data stream is broadcast over a second RF carrier chosen from a second set of RF carriers.

36. The system of claim 35, wherein the first set of RF carriers and the second set of RF carriers have selected RF carriers in common where the first data stream and the second data stream are carried.

37. The system of claim 35, wherein a location description of the first data stream further comprises control information that is related to at least one capability of a receiver and a location description of the second data stream comprises control information that is related to at least a second capability of the receiver.

38. The system of claim 35, wherein a receiver can recognize that a current RF channel on which the control information is decoded is the only RF channel carrying the first data stream by checking that a single RF channel identifier (RF_ID) is in a corresponding location description of the first data stream.

39. The system of claim 35, wherein the first set of RF carriers correspond to a first plurality of radio frequency (RF) channels and the second set of RF carriers correspond a second plurality of RF channels and wherein a receiver capable of decoding the first data stream can only decode data that is on one of the first plurality of RF channels.

40. The system of claim 35, wherein the first set of RF carriers correspond to a first plurality of radio frequency (RF) channels and the second set of RF carriers correspond to a second plurality of RF channels and wherein a receiver capable of decoding the second data stream can only decode data that is on one of the second plurality of RF channels.

41. The system of claim 35, wherein the first set of RF carriers correspond to a first plurality of radio frequency (RF) channels and the second set of RF carriers correspond to a second plurality of RF channels and wherein a receiver capable of decoding the first data stream and the second data stream can decode data that is on one of the second plurality of RF channels.

42. The system of claim 31, further comprising:
a first service area to which the first and second data streams are delivered; and
a second service area to which the first and second data streams are delivered;
wherein control information that is delivered to the first service area over control channels on a plurality of radio frequency channels is identical regardless of transmit mode.

43. The system of claim 31, further comprising:
a first service area to which the first and second data streams are delivered; and
a second service area to which the first and second data streams are delivered;
wherein control information that is delivered to the second service area over control channels on a plurality of radio frequency channels is identical regardless of transmit mode.

44. The system of claim 31, further comprising:
a signaling parameter channel information (SPC) field in the control channel, the signaling parameter channel information field indicating a radio frequency (RF) type, wherein a receiver uses the signaling parameter channel information field to set decoding registers in the receiver prior to moving to a different RF channel.

45. The system of claim 1, further comprising:
a signaling parameter channel information (SPC) field in the control channel, the signaling parameter channel information field comprising positioning pilot channel (PPC) presence bits, wherein a receiver uses the PPC presence bits to determine whether PPC symbols are broadcast on an RF channel prior to decoding the RF channel.
